(19) United States
(12) Patent Application Publication
(10) Pub. No.: US 2012/0298260 A1
(43) Pub. Date: Nov. 29, 2012

(54) Firewood Processor with Vertically-Displaceable Circular Saw

(75) Inventors: Douglas R. Kamps, Minocqua, WI (US); David A. Foytik, Phillips, WI (US); Marcus W. Steigerwaldt, Tomahawk, WI (US)

(73) Assignee: MULTITEK NORTH AMERICA, LLC, Prentice, WI (US)

(21) Appl. No.: 13/116,632

(22) Filed: May 26, 2011

(51) Int. Cl. B27C 9/00; B27B 31/00; B27L 7/00; B27B 5/02; B27B 29/00

(52) U.S. Cl. 144/4.6; 83/471.2; 83/401; 83/453; 83/418

(57) ABSTRACT

A firewood processor includes a main framework having a front end, rear end and opposite sides. A log infeed trough is supported on the main framework for advancing a log lengthwise along a longitudinal axis from the front end to the rear end of the main framework to a cutting station extending upwardly from the main framework for selectively cutting a log advanced on the log infeed trough into individual log rounds. An operator control station is positioned on the main framework for selectively controlling the advancing and the cutting of the log. The cutting station includes a rotating blade that is positioned above the log infeed trough and is mounted for upward and downward movement controlled by an operator at the control station in a vertical direction substantially perpendicular to the longitudinal axis of the trough to enable cutting of the log.

### BACKGROUND OF THE INVENTION

The present disclosure relates generally to an apparatus for processing harvested logs and, more particularly, pertains to a mobile log sawing and splitting machine employing a log cutting arrangement which maintains stability of the machine throughout operation thereof.

When logs are being processed into firewood, the most efficient way to do so is by using a firewood processor. This is a machine that cuts harvested logs into log segments or rounds, and then splits the log rounds into multiple pieces. Various machines have been designed to process logs into cut and split firewood, most of which utilize chain saw style cutting systems with a select few using a circular saw system. The circular saw system is the preferred method for cutting because it is faster and requires much less maintenance than a bar and chain style cutting system. Such prior art cutting systems generally utilize a chop style method wherein the cutting blade is pivotally mounted to one side of a conveying trough, and is swung laterally into and out of cutting engagement with a log advanced along the trough. When using this chop style blade or saw, problems arise due to the amount of weight transfer of the cutting blade during pivotal movement thereof which causes a shift in the balance point of the machine and results in a rocking, shifting or bouncing of the machine from side to side. The weight of the saw blade is transferred towards the rear of the machine, and leads to early frame fatigue and operator discomfort. This undesirable weight transfer can be particularly hazardous in smaller machines.

Accordingly, it is desirable to overcome the problems of prior art firewood processors, particularly in the cutting systems thereof, and provide a firewood processor wherein the weight of the saw blade is transitioned and smoothly controlled in a vertically displaceable motion that maintains the overall stability of the processor and improves the operating condition for the operator while performing an efficient cutting operation.

### SUMMARY OF THE INVENTION

The present disclosure relates to a firewood processor including a main framework having a front end, a rear end and opposite sides. A log infeed trough in supported on the main framework for advancing a log lengthwise along a longitudinal axis from the from the front end to the rear end of the main framework to a cutting station extending upwardly from the main framework for cutting a log advanced on the log infeed trough into individual log rounds. An operator control station is positioned on the main framework for selectively controlling the advancing and cutting of the log. The cutting station includes a rotating blade that is positioned above the log infeed trough, and is mounted for upward and downward movement. The upward and downward movement may be generally controlled by an operator at the control station and occurs in a vertical direction substantially perpendicular to the longitudinal axis of the trough to enable cutting of the log.

In an exemplary embodiment, the cutting station includes a tower framework having a hydraulic cylinder for selectively raising and lowering the rotating blade. The cutting station further includes a saw motor mount for supporting the rotating blade. The saw motor mount has a pair of guide rods that extend forwardly of the tower framework and move upwardly and downwardly through a bearing arrangement mounted to the saw tower framework. The rotating blade is provided with a guard that moves therewith and has an outlet for channeling saw dust therefrom. The operator control station is located rearwardly of the cutting station, and individually and manually controls advancing and cutting of the log. A reciprocating retainer arm is pivotally mounted on the main framework, and is swingable into and out of clamping engagement with a log to be cut on the log infeed trough. A splitting station is mounted on the main framework and is located beneath and behind the log infeed trough in direct alignment therewith.

The present disclosure also relates to a firewood processor including a main framework having a front end, a rear end and opposite sides. A log infeed trough is supported on the main frame for advancing a log lengthwise along a longitudinal axis from the front end to the rear end of the main framework to a cutting station extending upwardly from the main framework for cutting a log advanced on the log infeed trough into individual log rounds. A log supply deck extends laterally from the main framework and the log infeed trough for holding and feeding at least one log into the log infeed trough. An operator control station is positioned on the main framework rearwardly of the cutting station for selectively and manually controlling the feeding of the log on the supply deck into the log infeed trough, advancing the log along the trough towards the cutting station and cutting the log into log rounds. The cutting station includes a rotating blade that is positioned on a guide track above the log infeed trough, and mounted for upward and downward movement by an operator at the control station in a vertical direction substantially perpendicular to the longitudinal axis of the trough to enable cutting of the log.

The log supply deck is movable between a ground-engagable position and a storage position raised from the ground-engagable position. The log supply deck includes a set of spaced apart log-supporting beams provided with conveyors for advancing logs into the log infeed trough. The cutting station includes a tower framework, and the guide track includes a saw motor mount connected to a pair of guide rods that are engagable with a set of linear slide bearings mounted on the tower framework. A set of foraminous safety guards are provided forwardly and rearwardly of the cutting station.

The present disclosure further relates to a firewood processor including a main framework having a front end, a rear end and opposite sides. A log infeed trough is supported on the main framework for advancing a log lengthwise along a longitudinal axis from the front end to the rear end of the main framework to a cutting station extending upwardly from the main framework and having a vertically movable blade for cutting a log advanced on the log infeed trough into individual log rounds. A log supply deck extends laterally from the main framework and the log infeed trough for holding and feeding at least one log into the log infeed trough. A catch trough is located rearwardly of and beneath the log infeed trough for receiving the individual log rounds. An operator control station is positioned on the main framework for selectively and manually controlling the feeding of the log on the supply deck into the log infeed trough, advancing the log along the log infeed trough towards the cutting station, cutting the log into log rounds, and driving the log rounds from the catch trough into a splitting station located adjacent the rear end of the main framework. The log infeed trough, the catch trough and the splitting station are all in direct alignment with one another.

The cutting station includes a hydraulic cylinder for moving the blade upwardly and downwardly. An archway extends rearwardly from the cutting station over the catch trough. A pusher plate is mounted for back and forth movement along the catch trough. The log advancing, the driving of the log rounds and the splitting of the log rounds occur in a single direction along the longitudinal axis of the log infeed trough. The splitting station includes a splitter which is height adjustable relative to the main framework by means of a hydraulic cylinder and arm arrangement connected to the splitter.

### BRIEF DESCRIPTION OF THE DRAWINGS

The best mode of carrying out the invention is described herein below with reference to the following drawing figures.

FIG. 1 is a perspective view of a firewood processor in accordance with the present disclosure;

FIG. 2 is a front view of FIG. 1;

FIG. 3 is an elevational view of FIG. 1;

FIG. 4 is a plan view of FIG. 1;

FIG. 5 is a view similar to FIG. 2 with certain parts removed for clarity;

FIG. 6 is a rear view of FIG. 5;

FIG. 7 is a fragmentary plan view of a rear end of the firewood processor; and

FIG. 8 is an elevational view of FIG. 7.

### DETAILED DESCRIPTION

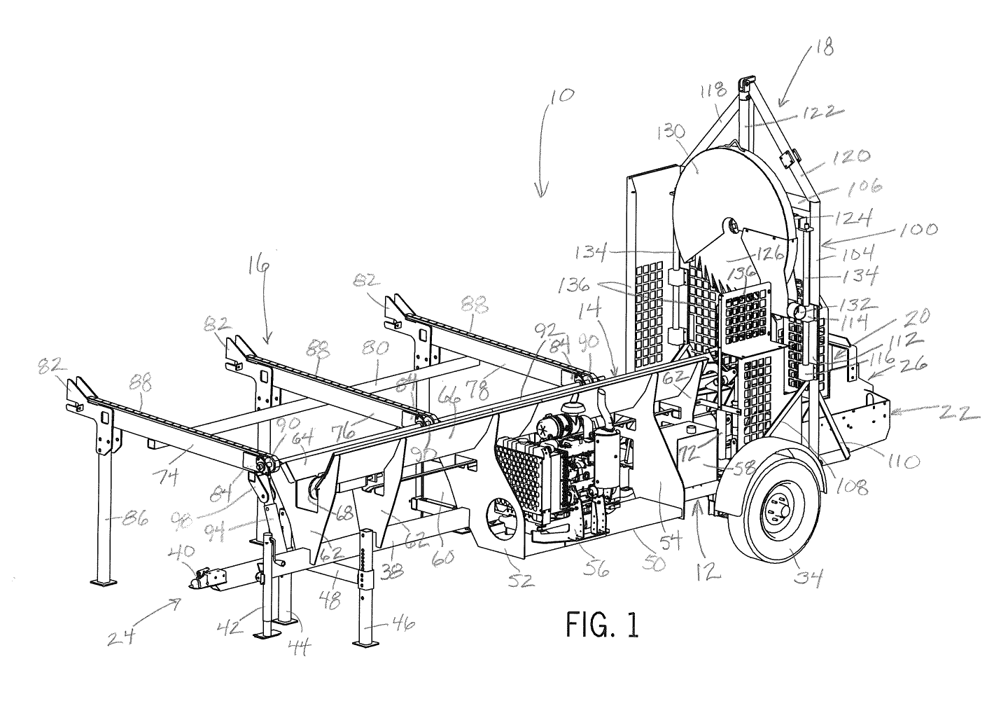

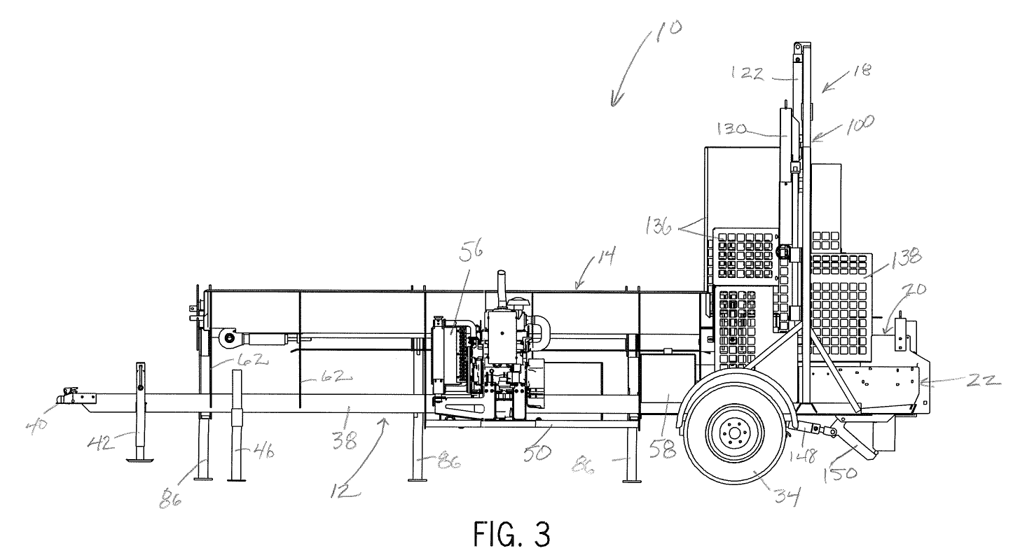

Referring now to FIGS. 1-3, thereshown is a firewood processor 10 in accordance with the present disclosure. The firewood processor 10 is preferably, but not necessarily, a mobile, trailer-based log sawing and splitting apparatus that includes a main framework 12 for supporting a log infeed trough 14, a log supply deck 16, a cutting station 18, a splitting station 20, and an operator control station 22.

In one embodiment of the present disclosure, the main framework 12 has a front end 24, a rear end 26, and opposite sides 28, 30, and is supported above the ground on a pair of wheels 32, 34 rotatably mounted on an axle 36 which is mounted to an underside of the framework 12. The main framework 12 may also include a forwardly extending tongue 38 having a hitch 40 attached to its outer end for connecting to a truck or other vehicle for transportation of the firewood processor 10 from one log processing site to another. An adjustable support jack 42, that is designed to rest on the ground during log processing, may be secured to a forward portion of the tongue 38. A set of ground-engagable stabilizer legs 44, 46 may be mounted for vertical adjustment on opposite ends of a connecting bar 48 fixed transversely beneath the tongue 38. A support platform 50 having end walls 52, 54 may also carried on the tongue 38, and can be used to hold a power unit such as a diesel or gasoline engine 56. The main framework 12 may also be used to mount a fuel tank 58 for the engine 56, and also a hydraulic oil tank 60 used in conjunction with a hydraulic pump powered by the engine 56.

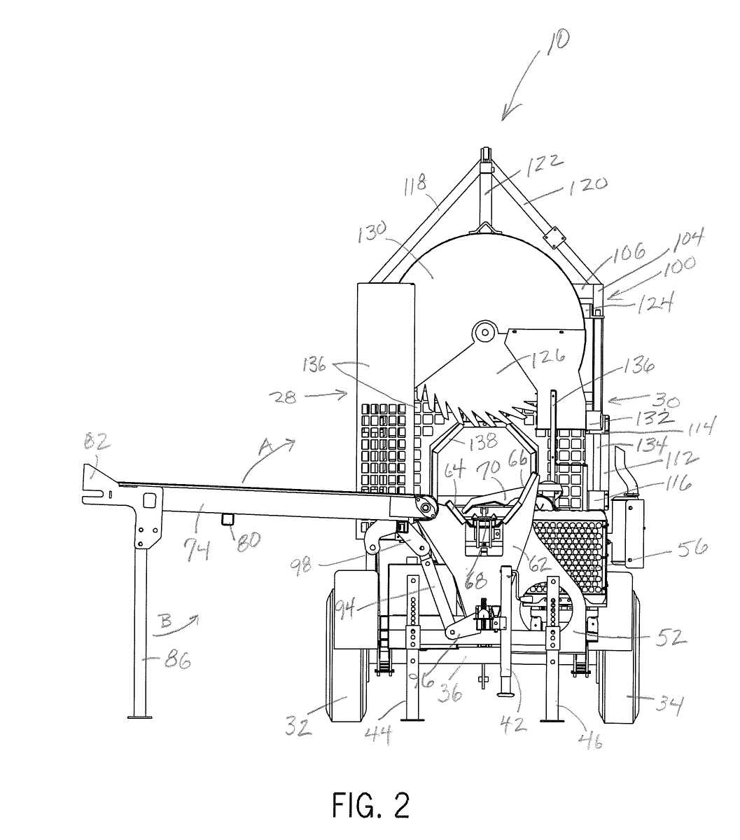

As seen best in FIG. 1, the log infeed trough 14 may be fixedly mounted on and above the main framework 12 by means of the end walls 52, 54 of the support platform 50, and by a number of upstanding support plates 62 spaced along the tongue 38. In an embodiment of the present disclosure, the trough 14 extends between the forwardmost support plate 62 and the cutting station 18. The trough 14 may include side walls 64, 66 and an open bottom including a chain conveyor 68 to aid in moving a log rearwardly along a longitudinal axis of the trough 14 towards the cutting station 18. Between a rearward end of the trough 14 and the cutting station 18, a reciprocating retainer arm 70 (FIG. 2) may be pivotally mounted on the main framework 12, and can be swung into and out of clamping engagement with a log to be cut by a hydraulic cylinder 72.

Logs are fed one at a time into the trough 14 by the log supply deck 16 that may extend laterally away from the trough 14. The log supply deck 16 preferably includes at least three spaced apart beams 74, 76, 78 oriented substantially transversely relative to the longitudinal axis of the trough 14, and interconnected by a rail 80 extending generally parallel to the longitudinal axis of the trough 14. Each of the beams 74, 76, 78 may include an inclined outer end 82 and an inner attachment end 84 pivotally connected to an upper portion of the main framework 12. In this instance, each outer end 82 of the beams 74, 76, 78 provides a pivotal mounting for a support leg 86 that normally engages a ground surface when the firewood processor 10 is in use. Each of the beams 74, 76, 78 may be provided with a chain conveyor 88, utilized to individually advance one or several logs deposited lengthwise across the beams 74, 76, 78 into trough 14. Each chain conveyor 88 may be mounted on a rotatable sprocket 90 that is fixed on a rod 92 and extends longitudinally outside of the trough 14. A hydraulic motor may be used to selectively drive the sprocket 90 on the inner end 84 of beam 76, and thereby simultaneously control the driving movement of the chain conveyors 88 on the supply deck 16. The side wall 66 may have an extended height in comparison with the opposite side wall 64 in order to help stop each log advanced from the log supply deck into the trough 14.

As seen best in FIG. 2, the supply deck 16 may be provided with a stabilizer 94 having a lower end joined to a connector 96 mounted on the main framework 12. In this instance, an upper end of the stabilizer 94 may be attached to a linkage 98 connected to the underside of beam 74. It should be understood that the beams 76, 78 may also be provided with a similar stabilizer 94, connector 96 and linkage 98. Although not shown, a hydraulic cylinder may be mounted between a connector 96 and the linkage 98 on the middle beam 76 to define a lifting arrangement for the supply deck 16. The hydraulic cylinder on the middle beam 76 can be extended to pivot the supply deck 16 upwardly in the direction of arrow A about the rod 92 to a storage position when it is desired to transport the firewood processor 10 to a different site. In this storage position, the support legs 86 are further pivoted in the direction of arrow B so that they are generally parallel to the beams 74, 76, 78.

The cutting station 18 is located adjacent the rearward end of the trough 14 and may include a rigid saw tower framework 100 that rises upwardly from a rear portion of the main framework 12. The saw tower framework 100 may include by a pair of uprights 102, 104 connected at their lower ends to the main framework 12, and may be further connected together at their upper ends by a cross piece 106. Lower portions of the uprights 102, 104 may be bolstered by diagonal braces 108, 110 (FIG. 8). Each of the uprights 102, 104 is capable of carrying a mounting plate 112 for mounting an upper linear slide bearing 114 and a lower linear slide bearing 116 that together may form a bearing arrangement on each side of the saw tower framework 100. An upper A-frame end of the saw tower framework 100 may be formed by a pair of struts 118, 120 connected together at upper ends thereof and also connected at lower ends thereof to outer ends of the cross piece 106. A hydraulic cylinder 122 may have an upper or casing end attached to the upper end junction of the struts 118, 120, and a lower or rod end joined to an elongated saw motor mount 124. The saw motor mount 124 is designed to allow for vertically upwardly and downwardly movement upon extension and retraction of the hydraulic cylinder 112. The saw motor mount 124 preferably carries a circular saw 126 that may be rotatably driven by a hydraulic saw motor 128 projecting rearwardly therefrom. As seen in FIG. 1, the circular saw 126 may also be provided with a saw guard 130 that partially surrounds the saw 126 and may be configured to move therewith. The saw guard 130 may include an outlet 132 for channeling saw dust therefrom during a sawing operation. Opposite ends of the saw motor mount 124 may further be provided with guide rods 134 that slide upwardly and downwardly through the linear slide bearings 114, 116 in response to operation of the hydraulic cylinder 122. The saw motor mount 124, the guide rods 134 and the linear slide bearings 114, 116 may form a guide track. As will be more fully described below, the circular saw 126 may be selectively rotated and moved up and down in guillotine fashion relative to saw tower framework 100 to selectively sever a log advanced along the trough 14 into a number of individual, separate log segments or rounds.

Referring to FIGS. 1-4, the cutting station 18 is preferably partially surrounded by foraminous safety guards 136 that rise upwardly from each side of the main framework 12 forwardly of the saw tower framework 100, and also extend partially downwardly along the rear thereof. The safety guard 136 behind the saw tower framework 100 may include a perforated archway 138 that extends over a catch trough 140 (FIG. 6) into which each severed log round falls. The safety guard 136 and the archway 138 can provide the operator with protection during operation and permit the desired visibility to efficiently perform the required processing functions. The catch trough 140 may be located directly below and rearwardly of the log infeed trough 14, and may include a movable pusher plate 142 designed to push several log rounds to the splitting station 20. The pusher plate 142 may be connected to a rod end 144 (FIG. 8) of a hydraulic cylinder positioned directly beneath the trough 14, and is selectively actuated to move the pusher plate 142 forwardly and rearwardly along the catch trough 134 in a cycle following each finished log cut.

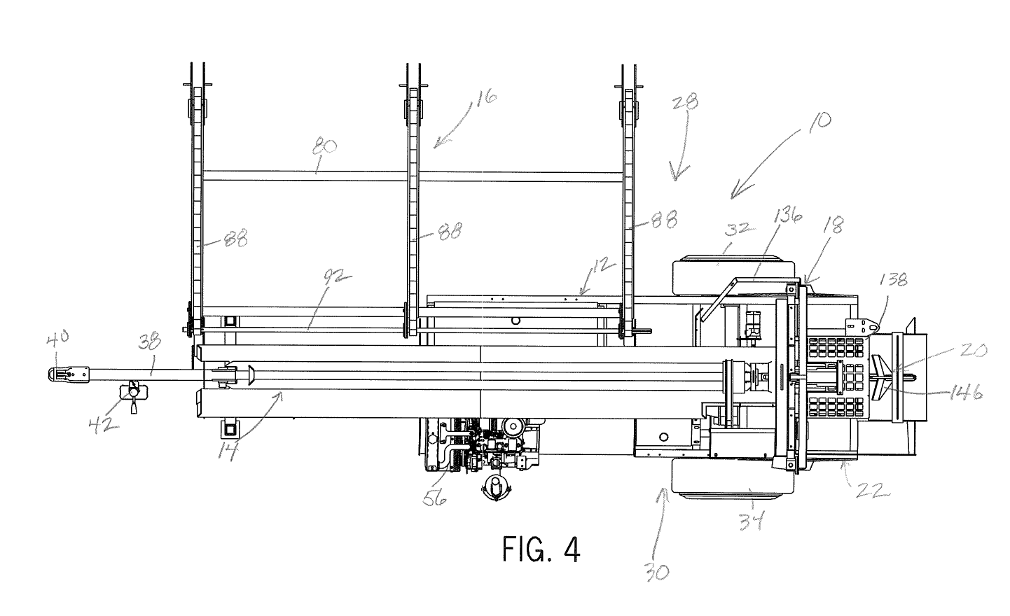

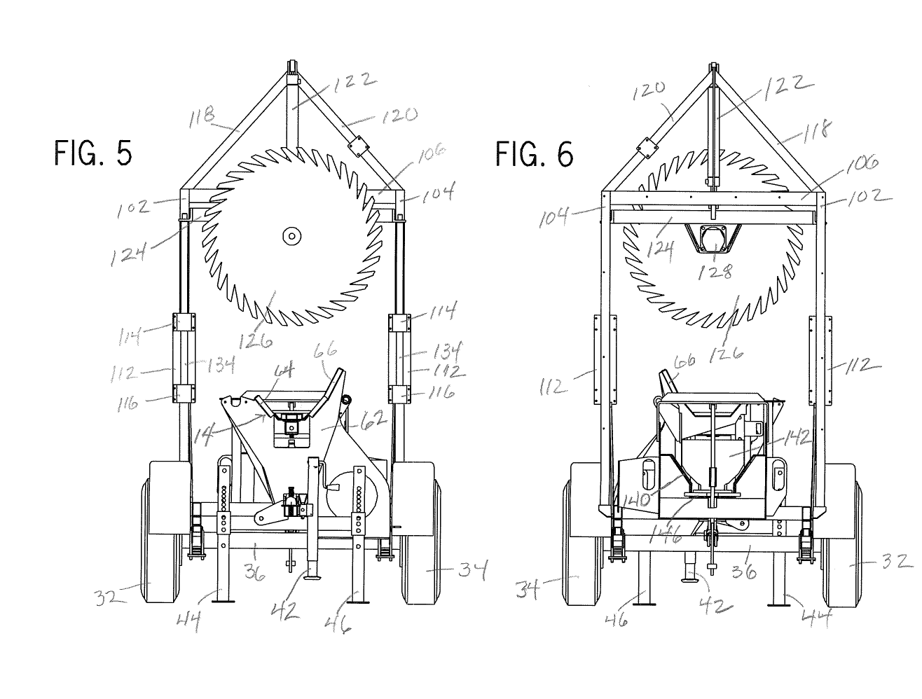

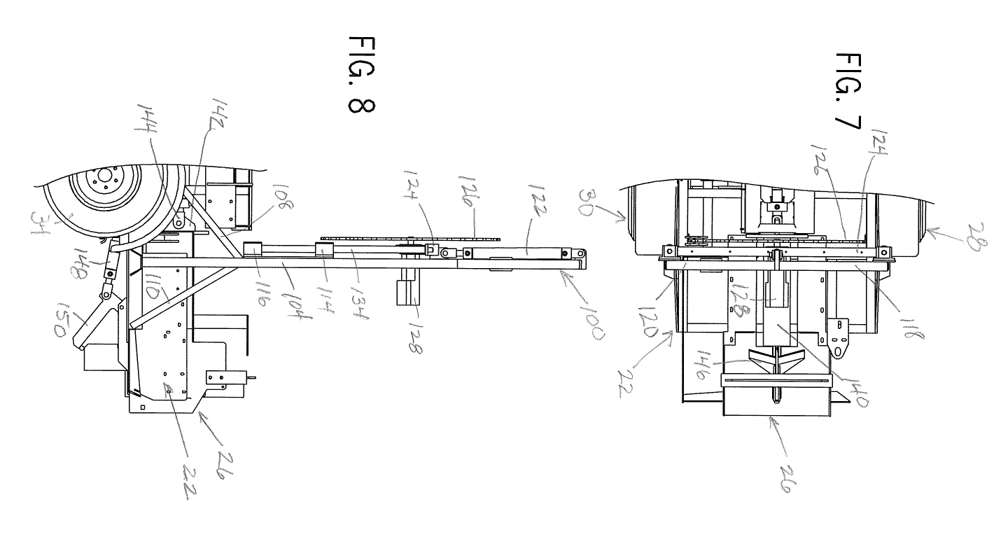

Referring to FIGS. 4, 6, 7 and 8, the splitting station 20 may include a cross shaped splitter 146 positioned rearwardly of the archway 138 and the catch trough 140. The splitter 146 may be constructed with tapered edge faces engagable with the log rounds to be split. The height of the splitter 146 is made adjustable to accommodate log rounds of different diameters by means of extending and retracting a hydraulic cylinder 148 connected to an arm 150 that engages the bottom of the splitter 146. Individual log rounds may therefore be forcefully pushed into and through the splitting station 20 so as to split the log rounds into quarters which exit from the rear end 26 of the firewood processor 10. Thereafter, the split log rounds are typically deposited onto a conveyor positioned at the rear end 26 for transporting the split logs to a pile or truck.

The firewood processor 10 may be operated using hydraulics from the operator control station 22 located near the rear end 26 of the main framework 12 on one side 30 thereof that carries the engine 56. The operator control station 22 may include a series of manually operated joysticks and/or other controls associated with a group of hydraulic valves that, when opened and closed, operate various working phases of the firewood processor 10. As is well known in the art, the hydraulic valves are connected by suitable hoses (not shown) to hydraulic motors and hydraulic cylinders as described above and are interconnected with the hydraulic oil tank 60 and the hydraulic pump which is conventionally driven by the engine 56. Using such an hydraulic system, an operator situated at the operator control station 22 is at a relatively safe, yet fully observable position at which he/she can manually perform each of the necessary processing functions as detailed below.

In use, a firewood processor 10 of the type described above is first moved to a site where a log sawing and splitting operation is desired. After reaching the site, the support jack 42 and stabilizer legs 44, 46 are lowered to stabilize and level the firewood processor 10. A separate loading machine places one or more delimbed logs on the supply deck 16 after the logs have been cut to a length which can be accommodated on the supply deck 16. The operator starts the circular saw 126 in the raised position shown in the drawings and activates the chain conveyors 88 of the supply deck 16 to feed an individual log into the log infeed trough 14. The log of the trough 14 is then moved rearwardly by the operator by actuating the chain conveyor 68 at the bottom of trough 14. When the rear end of the log reaches a predetermined location beyond the rear end of the trough 14, the operator moves the retaining arm 70 into a clamping position upon the log. The predetermined location may be established in many different manners as known in the art such as by using a stop strap that depends from a top end of the archway 138. The operator then energizes the hydraulic cylinder 122 and lowers the rotating circular saw 126 in a controlled guillotine style into the log such that a log section or round of desired length is separated from the log and falls into the catch trough 140. The log cutting thus occurs in a vertical direction substantially perpendicular to the longitudinal axis of the trough 14. The operator next raises the rotating circular saw 126, and then actuates the hydraulic cylinder to drive the severed log round via the pusher plate 142 into the splitter 146 after which the pusher plate 142 is retracted in the catch trough 140. Each of the split log pieces either falls to the ground or preferably is deposited onto a separate conveyor mounted at the rear end 126 of the firewood processor 10. It should be appreciated that the log advancing and sawing process along the trough, as well as the splitting process, all occur in a single direction directly along the longitudinal axis of the trough 14 enabling the operator to visually observe, monitor and control the entire operation in a continuous manner.

Accordingly, the present disclosure thus provides a mobile firewood processor in which various processing functions, including log sawing and splitting, are selectively performed manually and individually by a single operator in an in-line manner on a single machine. Notably, the firewood processor shown and described herein employs a vertically displaceable circular cutting saw which, in use, eliminates the side to side, rocking, shifting and bouncing of the processing machine normally encountered in previously known firewood processors that use a chain or circular saw that pivots or swings about an axis spaced from the path of log transfer, and causes an undesirable lateral weight shift during operation. The saw of the present disclosure follows a controlled vertical path to provide a cutting motion without any side to side weight transfer so as to minimize machine stress and framework fatigue and improve operator comfort.

Various alternatives are contemplated as being within the scope of the following claims particularly pointing out and distinctly claiming the subject matter regarded as the invention.

What is claimed is:

1. A firewood processor comprising:
a main framework having a front end, a rear end and opposite sides;
a log infeed trough supported on the main framework for advancing a log lengthwise along a longitudinal axis from the front end to the rear end of the main framework to a cutting station, the cutting station extending upwardly from the main framework for cutting a log advanced on the log infeed trough; and
wherein the cutting station includes a rotating blade located above the log infeed trough, and mounted for upward and downward movement, in a vertical direction substantially perpendicular to the longitudinal axis of the trough to cut a log.

2. The firewood processor of claim 1, wherein the cutting station includes a tower framework having a hydraulic cylinder for selectively raising and lowering the rotating blade.

3. The firewood processor of claim 2, wherein the cutting station further includes a saw motor mount for supporting the rotating blade, the saw motor mount having a pair of guide rods that extend forwardly of the tower framework and move upwardly and downwardly through a bearing arrangement mounted to the saw tower framework.

4. The firewood processor of claim 1, wherein the rotating blade is provided with a guide that moves therewith.

5. The firewood processor of claim 4, wherein the guard is provided with an outlet for channeling saw dust therefrom.

6. The firewood processor of claim 1, wherein the processor further comprises an operator control station positioned on the main framework for selectively controlling the advancing and cutting of the log, and wherein the operator control station is located rearwardly of the cutting station.

7. The firewood processor of claim 6, wherein the operator control station separately controls advancing and cutting of the log.

8. The firewood processor of claim 1, wherein a reciprocating retainer arm is pivotally mounted on the main framework, and is movable into and out of clamping engagement with a log to be cut on the log infeed trough.

9. The firewood processor of claim 1, wherein a splitting station is located beneath and behind the log infeed trough in alignment therewith.

10. The firewood processor of claim 1, wherein the processor further comprises a log supply deck extending laterally from the main framework and the log infeed trough for holding at least one log and feeding the at least one log into the log infeed trough.

11. A firewood processor comprising:
a main framework having a front end, a rear end and opposite sides;
a log infeed trough supported on the main framework for advancing a log lengthwise along a longitudinal axis from the front end to the rear end of the main framework to a cutting station, the cutting station extending upwardly from the main framework for cutting a log advanced on the log infeed trough;
a log supply deck extending laterally from the main framework and the log infeed trough for holding at least one log and feeding the at least one log into the log infeed trough;
an operator control station positioned on the main framework rearwardly of the cutting station for selectively and manually controlling the feeding of the log on the log supply deck into the log infeed trough, advancing the log along the trough towards the cutting station, and cutting the log into log rounds,
wherein the cutting station includes a rotating blade positioned on a guide track above the log infeed trough, the rotating blade mounted for upward and downward movement in a vertical direction substantially perpendicular to the longitudinal axis of the trough to enable cutting of the log.

12. The firewood processor of claim 11, wherein the log supply deck is movable between a ground-engagable position and a storage position raised from the ground engagable position.

13. The firewood processor of claim 11, wherein the log supply deck includes a set of spaced apart, log-supporting beams provided with conveyors for advancing logs into the log infeed trough.

14. The firewood processor of claim 11, wherein the cutting station includes a tower framework, and the guide track includes a saw motor mount connected to a pair of guide rods that are engagable with a set of linear slide bearings mounted on the tower framework.

15. The firewood processor of claim 11, wherein foraminous safety guards are provided forwardly and rearwardly of the cutting station.

16. A firewood processor comprising:
a main framework having a front end, a rear end and opposite sides;
a log infeed trough supported on the main framework for advancing a log lengthwise along a longitudinal axis from the front end to the rear end of the main framework to a cutting station; the cutting station extending upwardly from the main framework and having a vertically movable blade for cutting a log advanced on the log infeed trough;
a log supply deck extending laterally from the main framework and the log infeed trough for holding at least one log and feeding the at least one log into the log infeed trough;
a catch trough located rearwardly of and beneath the log infeed trough for receiving the individual log rounds;
a splitting station located beneath and behind the catch trough for splitting the individual log rounds; and
an operator control station positioned on the main framework controlling the feeding of the log on the log supply deck into the log infeed trough, advancing the log along the log infeed trough towards the cutting station, cutting the log into log rounds, and driving the log rounds along the catch trough into the splitting station;
wherein the log infeed trough, the catch trough and the splitting station are all in linear alignment with one another.

17. The firewood processor of claim 16, wherein the cutting station includes a hydraulic cylinder for moving the blade upwardly and downwardly.

18. The firewood processor of claim 16, wherein an archway extends rearwardly from the cutting station over the catch trough.

19. The firewood processor of claim 16, wherein a pusher plate is mounted for back and forth movement along the catch trough.

20. The firewood processor of claim 16, wherein the splitting station includes a splitter of adjustable height relative to the main framework, wherein the adjustment is made by means of a hydraulic cylinder and arm arrangement connected to the splitter.
